(19) United States
(12) Patent Application Publication
(10) Pub. No.: US 2008/0297335 A1
(43) Pub. Date: Dec. 4, 2008

(54) DRIVING EFFICIENCY MANAGEMENT APPARATUS AND METHOD THEREOF

(75) Inventors: Han-Kuo Yeh, Taipei City (TW); Yang-Han Lee, Taipei City (TW); Yiu-Sung Pao, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: BEYOND INNOVATION TECHNOLOGY CO., LTD., Taipei City (TW)

(21) Appl. No.: 12/043,075

(22) Filed: Mar. 5, 2008

(30) Foreign Application Priority Data
May 30, 2007 (TW) 96119278

(51) Int. Cl. B60Q 1/00

(52) U.S. Cl. 340/439; 345/8

(57) ABSTRACT

A driving efficiency management apparatus and a method thereof are provided. The driving efficiency management apparatus includes a detection unit, a storage unit, a processing unit, and a display. The detection unit detects the driving condition of a vehicle and generates a driving information. The storage unit receives and stores the driving information. The processing unit compares the driving information and generates an economical performance information and an optimal driving operation information according to the comparison result. The display displays the economical performance information or the optimal driving operation information.

### CROSS-REFERENCE TO RELATED APPLICATION

This application claims the priority benefit of Taiwan application serial no. 96119278, filed on May 30, 2007. The entirety the above-mentioned patent application is hereby incorporated by reference herein and made a part of specification.

### BACKGROUND OF THE INVENTION

1. Field of the Invention

The present invention generally relates to an efficiency management apparatus, in particular, to an in-car driving efficiency management apparatus and a method thereof.

2. Description of Related Art

Petroleum is the most broadly applied and convenient source of energy in the world. All the cars and motors use gasoline produced from petroleum as their energy source. However, global petroleum reserves are not endless. According to expert estimation, the average number of exploitation years for global petroleum reserves is only about 41 years, while it is only about 62 years for natural gas.

Since global petroleum reserves are limited, at current consumption levels, this resource would be eventually used up. At that time, a global energy crisis would be confronted by the whole world, and all the vehicles which use gasoline as their energy source would be invalidated.

In addition, the price of petroleum has been increasing along with the gradual decrease in global petroleum reserves. Consumers have to pay for very high price in order to sustain the normal operation of their vehicles, and such a situation will go on to further increase the burden of the consumers.

Accordingly, before any new energy source for replacing petroleum is developed, reducing energy consumption is the most direct and effective way for reducing consumers' heavy load on high gasoline price.

### SUMMARY OF THE INVENTION

Accordingly, the present invention is directed to a driving efficiency management apparatus which displays an economical performance information and an optimal driving operation information in a screen for controlling the gasoline consumption of a vehicle and adjusting the driving behaviours of a driver so as to improve the driving operation of the driver.

The present invention is directed to a driving efficiency management method, wherein the driving efficiency of a driver is evaluated, which, besides being used for improving the driving behaviours of the driver, is also used as reference data for assessing the performance of the driver.

The present invention provides a driving efficiency management apparatus including a detection unit, a storage unit, a processing unit, and a display. The detection unit obtains a driving information according to the driving condition of a vehicle. The storage unit receives and stores the driving information. The processing unit compares the driving information and generates an economical performance information and an optimal driving operation information according to the comparison result. The display displays the economical performance information or the optimal driving operation information.

The present invention provides a driving efficiency management method. The method includes: obtaining a driving information according to the driving condition of a vehicle in real time; comparing the driving information and generating an economical performance information and an optimal driving operation information according to the comparison result; and dynamically displaying the economical performance information or the optimal driving operation information.

In the present invention, an integrated structure comprising a trip computer, a global positioning system (GPS), and a gravity sensor is adopted to directly obtain the driving information of a vehicle, so that the driving information can be calculated in real time and an economical performance information and an optimal driving operation information can be displayed for controlling the gasoline consumption of the vehicle and adjusting inappropriate driving behaviours of the driver.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a driving efficiency management apparatus according to an embodiment of the present invention.

FIG. 2 is a flowchart of a driving efficiency management method according to an embodiment of the present invention.

FIG. 3 illustrates an implementation of a driving efficiency management apparatus according to an embodiment of the present invention.

FIG. 4 is a flowchart for accomplishing the implementation in FIG. 3.

FIG. 5 illustrates another implementation of a driving efficiency management apparatus according to an embodiment of the present invention.

FIG. 6 is a flowchart for accomplishing the implementation in FIG. 5.

FIG. 7 illustrates yet another implementation of a driving efficiency management apparatus according to an embodiment of the present invention.

FIG. 8 is a flowchart for accomplishing the implementation in FIG. 7.

FIG. 9 is a block diagram of a driving efficiency management apparatus according to another embodiment of the present invention.

FIG. 10 is a flowchart illustrating the performance management in a management center.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

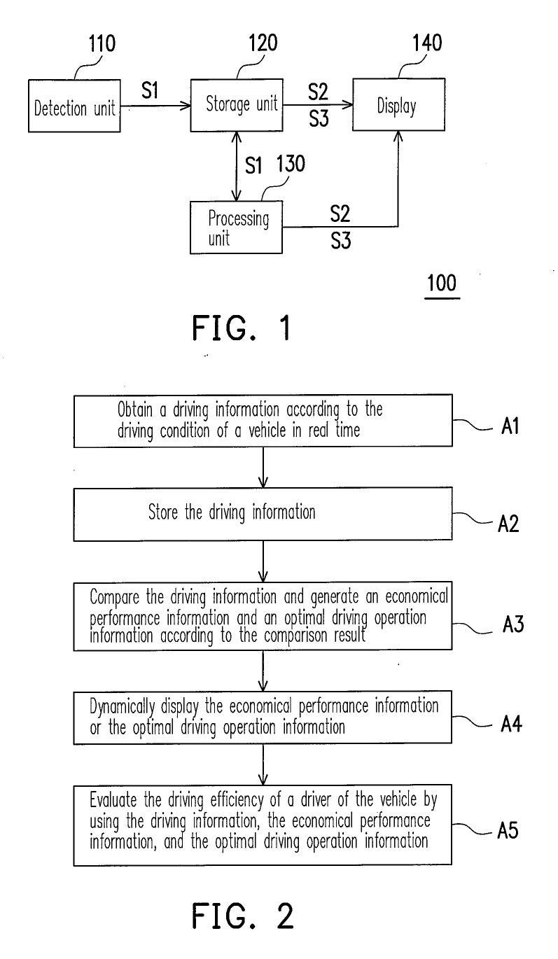

FIG. 1 is a block diagram of a driving efficiency management apparatus according to the first embodiment of the present invention. In the present embodiment, the driving efficiency management apparatus is disposed in a vehicle. Referring to FIG. 1, the driving efficiency management apparatus 100 includes a detection unit 110, a storage unit 120, a processing unit 130, and a display 140. The detection unit 110 is coupled to the storage unit 120, the storage unit 120 is coupled to the processing unit 130 and the display 140, and the processing unit 130 is coupled to the display 140. FIG. 2 is a flowchart of a driving efficiency management method according to the first embodiment of the present invention. The spirit of the present invention will be described herein with reference to FIG. 1 and FIG. 2.

First, the detection unit 110 obtains a driving information S1 of the vehicle in real time according to the driving condition of the vehicle (step A1). Next, the storage unit 120 stores the driving information S1 obtained by the detection unit 110 and provides the driving information S1 to the processing unit 130 (step A2). The processing unit 130 compares the driving information S1 and generates an economical performance information S2 and an optimal driving operation information S3 according to the comparison result (step A3).

Thereafter, the processing unit 130 transmits the economical performance information S2 and the optimal driving operation information S3 to the display 140, and the display 140 dynamically displays the economical performance information S2 or the optimal driving operation information S3 according to the instruction of the processing unit 130 (step A4). Finally, the driving skill and driving efficiency of the driver on this vehicle are evaluated by integrating the driving information S1, the economical performance information S2, and the optimal driving operation information S3 (step A5).

Additionally, besides being directly transmitted by the processing unit 130, the economical performance information S2 and the optimal driving operation information S3 to be displayed by the display 140 may also be transmitted by the processing unit 130 via the storage unit 120.

The main structure of the present invention has been described in foregoing embodiment, and examples of how to accomplish the spirit of the present invention will be described below.

### Second Embodiment

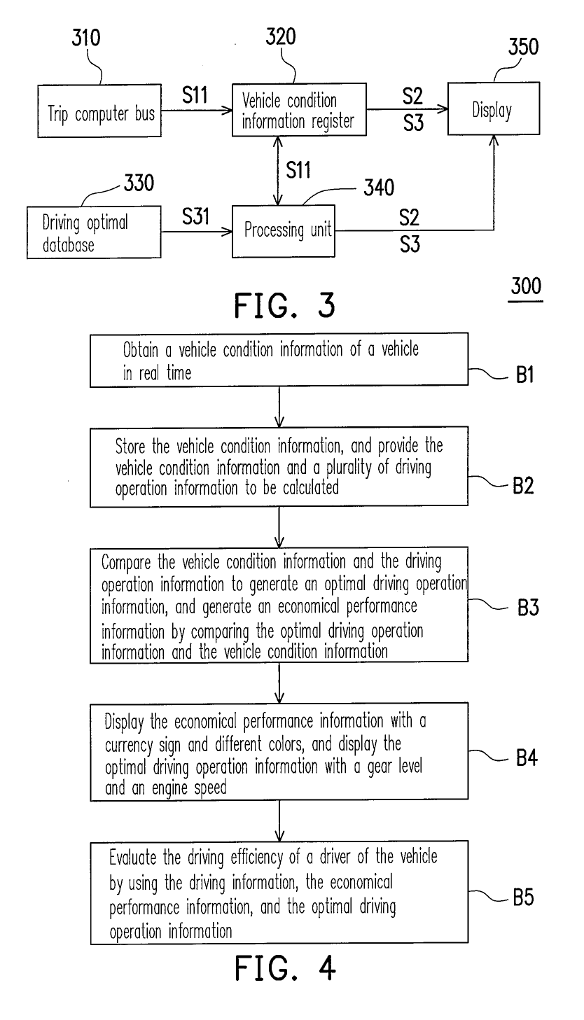

FIG. 3 illustrates an implementation of a driving efficiency management apparatus according to the second embodiment of the present invention. Referring to FIG. 3, in the present embodiment, the driving efficiency management apparatus 300 includes a detection unit, a storage unit, a driving optimal database 330, a processing unit 340, and a display 350. The driving optimal database 330 is coupled to the processing unit 340 for storing a plurality of driving operation information S31.

In the present embodiment, the detection unit has a trip computer bus 310 for obtaining a vehicle condition information S11. The trip computer bus 310 is connected to a trip computer in the vehicle for receiving the vehicle condition information S11 from the trip computer. The storage unit includes a vehicle condition information register 320 for storing the vehicle condition information S11.

FIG. 4 is a flowchart for accomplishing the implementation in FIG. 3. The operation flow in the present embodiment will be described herein with reference to FIG. 3 and FIG. 4. First, the trip computer bus 310 is connected to the trip computer to obtain the vehicle condition information S11 of the vehicle in real time (step B1). Next, the vehicle condition information S11 is transmitted to the vehicle condition information register 320 and provided to the processing unit 340 together with the driving operation information S31 stored in the driving optimal database 330 (step B2).

The processing unit 340 then performs a calculation on foregoing information S11 and S31. During the calculation, the processing unit 340 compares the vehicle condition information S11 and the driving operation information S31 to select one of the driving operation information S31 as an optimal driving operation information S3 and generates an economical performance information S2 by comparing the optimal driving operation information S3 and the vehicle condition information S11 (step B3).

Thereafter, the processing unit 340 transmits the economical performance information S2 and the optimal driving operation information S3 to the display 140, and the display 140 displays the economical performance information S2 or the optimal driving operation information S3 according to the instruction of the processing unit 130, wherein the economical performance information S2 is displayed with a currency sign and different colors (for example, $+111 or $−222, displayed in green for indicating positive performance and red for indicating negative performance etc), and the optimal driving operation information S3 is displayed in gear level and/or engine speed (step B4). Finally, the driving skill and driving efficiency of the driver on this vehicle are evaluated by integrating the driving information S1, the economical performance information S2, and the optimal driving operation information S3 (step B5).

### Third Embodiment

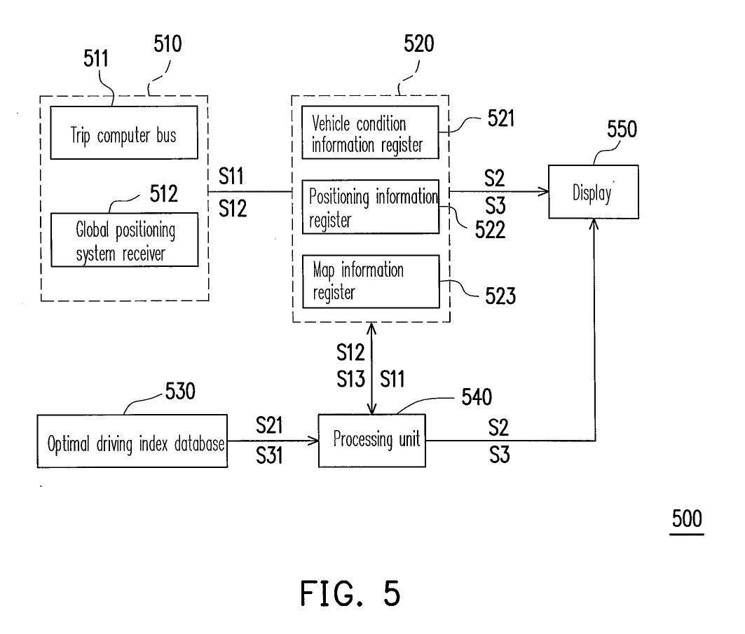

FIG. 5 illustrates another implementation of a driving efficiency management apparatus according to the third embodiment of the present invention. Referring to FIG. 5, in the present embodiment, the driving efficiency management apparatus 500 includes a detection unit 510, a storage unit 520, an optimal driving index database 530, a processing unit 540, and a display 550. The optimal driving index database 530 is coupled to the processing unit 540 for storing a plurality of economical road sections S21 and a plurality of driving operation information S31.

In the present embodiment, the detection unit 510 has a trip computer bus 511 and a global positioning system (GPS) receiver 512 for obtaining a vehicle condition information S11 and a longitude/latitude information S12. The trip computer bus 511 is connected to a trip computer in the vehicle for receiving the vehicle condition information S11 from the trip computer. The GPS receiver 512 provides the longitude/latitude information S12. The storage unit 520 includes a vehicle condition information register 521, a positioning information register 522, and a map information register 523, wherein the vehicle condition information register 521 stores the vehicle condition information S11, the positioning information register 522 stores the longitude/latitude information S12, and the map information register 523 stores a local information S13.

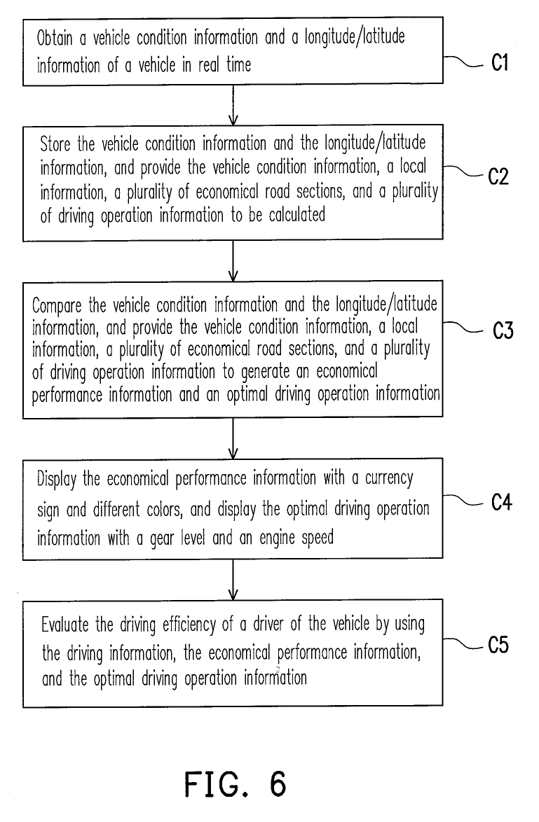

FIG. 6 is a flowchart for accomplishing the implementation in FIG. 5. The operation flow in the present embodiment will be described herein with reference to FIG. 5 and FIG. 6. First, the trip computer bus 511 is connected to the trip computer for receiving the vehicle condition information S11 of the vehicle, and the GPS receiver 512 receives a GPS satellite signal and obtains the longitude/latitude information S12 according to the longitude/latitude coordinates of the vehicle (step C1). Next, the vehicle condition information S11 is transmitted to the vehicle condition information register 521, the longitude/latitude information S12 is transmitted to the positioning information register 522, and the vehicle condition information 511 and the longitude/latitude information S12 are provided to the processing unit 540 together with the local information S13 stored in the map information register 523 and the economical road sections S21 and driving operation information S31 stored in the optimal driving index database 530 (step C2).

The processing unit 540 performs a calculation on foregoing information S11, S12, S13, S21, and S31. During the calculation, the processing unit 540 first compares the longitude/latitude information S12 obtained in real time with the local information S13 to obtain the current position of the vehicle, and after that, the processing unit 540 compares the longitude/latitude information S12 obtained in real time with the economical road sections S21 stored in the optimal driving index database 530, wherein if the current position of the vehicle falls within one of the economical road sections S21, this economical road section S21 is determined to be a specific road section of the vehicle. After obtaining the specific road section of the vehicle, the processing unit 540 selects one of the driving operation information S31 corresponding to the specific road section as the optimal driving operation information S3 of the specific road section and compares the optimal driving operation information S3 with the vehicle condition information S11 to generate an economical performance information S2 (step C3).

Thereafter, the processing unit 130 transmits the economical performance information S2 and the optimal driving operation information S3 to the display 550, and the display 550 displays the economical performance information S2 or the optimal driving operation information S3 according to the instruction of the processing unit 540 in real time, wherein the economical performance information S2 is displayed with a currency sign and different colors (for example, $+111 or $−222, green for indicating positive performance, and red for indicating negative performance etc), and the optimal driving operation information S3 is displayed in gear level and/or engine speed (step C4). Finally, the driving skill and driving efficiency of the driver on this vehicle are evaluated by integrating the driving information S1, the economical performance information S2, and the optimal driving operation information S3 (step C5).

### Fourth Embodiment

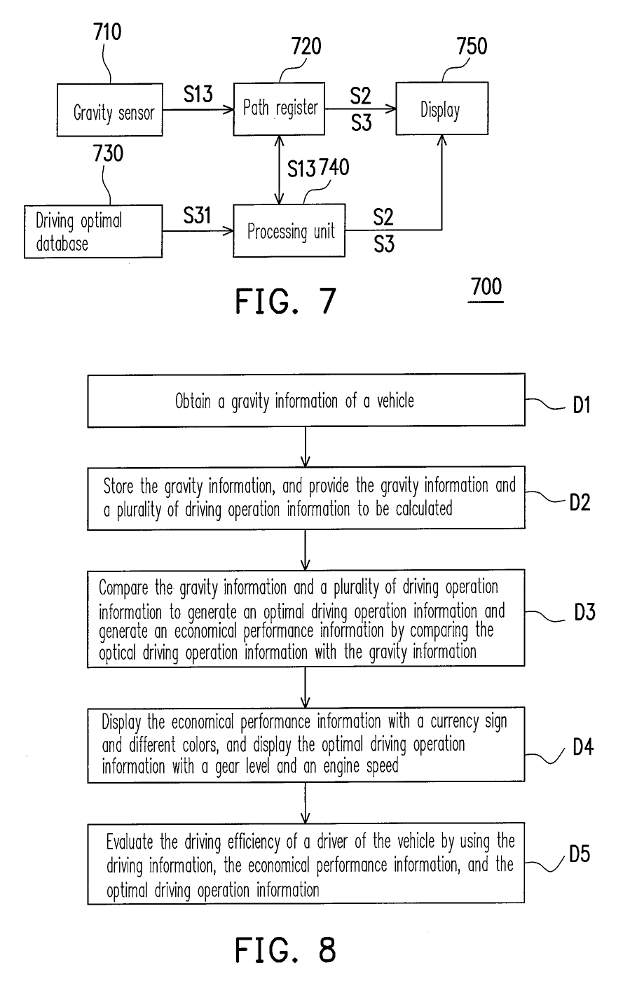

FIG. 7 illustrates yet another implementation of a driving efficiency management apparatus according to the fourth embodiment of the present invention. Referring to FIG. 7, in the present embodiment, the driving efficiency management apparatus 700 includes a detection unit, a storage unit, a driving optimal database 730, a processing unit 740, and a display 750. The detection unit has a gravity sensor 710 for generating a gravity information S13. The gravity sensor 710 senses a relative moving path of the vehicle to generate the gravity information S13. The storage unit includes a path register 720 for storing the gravity information S13.

FIG. 8 is a flowchart for accomplishing the implementation in FIG. 7. The operation flow in the present embodiment will be described herein with reference to FIG. 7 and FIG. 8. First, when the vehicle is running, it may have such actions as acceleration, brake, turnaround, and vibration due to the road condition or the driving behaviors of the driver. Here the gravity sensor detects the gravity value of such an action to generate a gravity information S13 (step D1). Next, the gravity information S13 is transmitted to the path register 720 and provided to the processing unit 740 together with a plurality of driving operation information S31 stored in the driving optimal database 730 (step D2).

The processing unit 740 performs a calculation on foregoing information S13 and S31. During the calculation, the processing unit 740 compares the gravity information S13 and the driving operation information S31 to select one of the driving operation information S31 as an optimal driving operation information S3, and the processing unit 740 generates an economical performance information S2 by comparing the optimal driving operation information S3 with the vehicle condition information S11 (step D3).

Thereafter, the processing unit 740 transmits the economical performance information S2 and the optimal driving operation information S3 to the display 750, and the display 750 displays the economical performance information S2 or the optimal driving operation information S3 according to the instruction of the processing unit 740 in real time, wherein the economical performance information S2 is displayed with a currency sign and different colors (for example, $+111 or $−222, displayed in green for indicating positive performance, and red for indicating negative performance), and the optimal driving operation information is displayed in gear level and/or engine speed, torsion curve, horsepower curve along with vehicle load (step D4). Finally, the driving skill and driving efficiency of the driver on this vehicle are evaluated by integrating the driving information S1, the economical performance information S2, and the optimal driving operation information S3 (step D5).

It should be mentioned here that the displays in embodiments of the present invention may be any types of displays including head-up display (HUD) broadly used in vehicles. The trip computer buses in foregoing embodiments may be controller area network buses (CAN-buses). However, the present invention is not limited thereto, and it should be understood by those skilled in the art that it is within the scope and spirit of the present invention even though the trip computer disposed in a vehicle conforms to another information transmission specification.

Additionally, the driving efficiency management apparatus in an embodiment of the present invention has an information transmission function therefore can transmit the driving information S1, the economical performance information S2, and the optimal driving operation information S3 to a management center, so that the management center can manage and evaluate the information.

### Fifth Embodiment

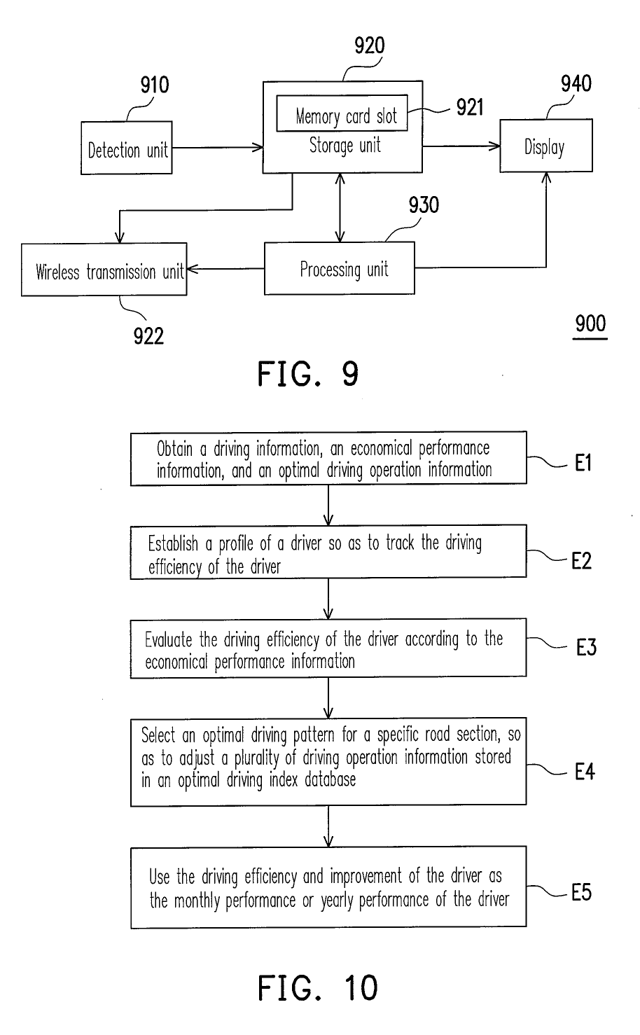

FIG. 9 is a block diagram of a driving efficiency management apparatus according to the fifth embodiment of the present invention. Referring to FIG. 9, in the present embodiment, the driving efficiency management apparatus 900 includes a detection unit 910, a storage unit 920, a processing unit 930, a display 940, a memory card slot 921, and a wireless transmission unit 922. The memory card slot 921 is coupled to the storage unit 920, the wireless transmission unit 922 is coupled to the storage unit 920 and the processing unit 930, and the couplings of the other components are similar to those in foregoing embodiments therefore will not be described herein. FIG. 10 is a flowchart illustrating the performance management in a management center. The detailed operation of performance management will be described herein with reference to FIG. 9 and FIG. 10.

After the driving efficiency management apparatus 900 obtains the driving information S1, the economical performance information S2, and the optimal driving operation information S3, the processing unit 130 stores the information into the storage unit 120, and the storage unit 120 copies the information into a memory card. The management center can then obtains the driving information S1, the economical performance information S2, and the optimal driving operation information S3 from the memory card. In addition, the driving efficiency management apparatus 900 may also transmit the information to the management center through the wireless transmission unit 922, and accordingly, the management center may obtain the information through wireless communication.

After the management center obtains the driving information S1, the economical performance information S2, and the optimal driving operation information S3 from the memory card or through wireless communication (step E1), the management center stores the information for the convenience of management. The management center then establishes a profile of the driver such that the driving efficiency of the driver can be tracked (step E2). After that, the management center evaluates the driving efficiency of the driver according to the economical performance information S1 (step E3). Next, the management center compares the driving efficiency of the driver with the driving efficiencies of other drivers to select the optimal driving pattern at a specific road section, so as to adjust a plurality of driving operation information S31 stored in an optimal driving index database (step E4). Finally, the management center uses the driving efficiency and improvement of the driver as the monthly performance or yearly performance of the driver (step E5).

In summary, in the present invention, the driving information of a vehicle is obtained in real time by adopting an integrated structure comprising a trip computer, a GPS, and a gravity sensor, and the current gasoline consumption situation of the vehicle is then obtained in real time by comparing the driving information, so as to adjust the driving behaviors of the driver instantly. Moreover, the driving information, an economical performance information, and an optimal driving operation information are transmitted to a management center through a general memory card or a built-in wireless communication method, so that the management center can easily obtain foregoing information, which makes backup and management of the information very convenient.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving efficiency management apparatus, comprising:
a detection unit, for obtaining a driving information according to the driving condition of a vehicle in real time;
a storage unit, for storing the driving information;
a processing unit, for comparing the driving information and generating an economical performance information and an optimal driving operation information according to the comparison result; and
a display, for displaying the economical performance information or the optimal driving operation information.

2. The driving efficiency management apparatus according to claim 1, wherein the display displays the economical performance information with a currency sign.

3. The driving efficiency management apparatus according to claim 1, wherein the optimal driving operation information comprises a gear level and an engine speed of the vehicle.

4. The driving efficiency management apparatus according to claim 1, wherein the display is a head-up display (HUD) in the vehicle.

5. The driving efficiency management apparatus according to claim 1, wherein the driving information comprises a longitude/latitude information and a vehicle condition information, and the detection unit comprises:
a trip computer bus, for transmitting the vehicle condition information through a connection to an trip computer of the vehicle; and
a global positioning system (GPS) receiver, coupled to the storage unit, the GPS receiver receiving a GPS satellite signal to obtain the longitude/latitude coordinates of the vehicle and generating the longitude/latitude information according to the longitude/latitude coordinates, wherein the processing unit compares the longitude/latitude information with a plurality of local information to determine whether the driving route of the vehicle passes through a specific road section, when the vehicle runs in the specific road section, the processing unit selects one of a plurality of driving operation information as the optimal driving operation information and generates the economical performance information by comparing the optimal driving operation information with the vehicle condition information.

6. The driving efficiency management apparatus according to claim 5, wherein the storage unit comprises:
a vehicle condition information register, for storing the vehicle condition information;
a map information register, for providing the local information; and
a positioning information register, for storing the longitude/latitude information.

7. The driving efficiency management apparatus according to claim 5 further comprising:
an optimal driving index database, for providing the driving operation information and a plurality of economical road sections,
wherein the processing unit selects one of the economical road sections as the specific road section according to the current position of the vehicle.

8. The driving efficiency management apparatus according to claim 5, wherein the trip computer bus is a controller area network bus (CAN-bus).

9. The driving efficiency management apparatus according to claim 1, wherein the driving information comprises a vehicle condition information, and the detection unit comprises:
a trip computer bus, for transmitting the vehicle condition information through a connection to the trip computer of the vehicle,
wherein the processing unit compares the vehicle condition information and a plurality of driving operation information to select one of the driving operation information as the optimal driving operation information and generates the economical performance information by comparing the optimal driving operation information and the vehicle condition information.

10. The driving efficiency management apparatus according to claim 9, wherein the storage unit comprises:
a vehicle condition information register, for storing the vehicle condition information.

11. The driving efficiency management apparatus according to claim 9 further comprising:
a driving optimal database, for providing the driving operation information.

12. The driving efficiency management apparatus according to claim 9, wherein the trip computer bus is a CAN-bus.

13. The driving efficiency management apparatus according to claim 1, wherein the driving information comprises a gravity information, and the detection unit comprises:
a gravity sensor, for sensing a relative moving path of the vehicle and generating the gravity information according to the relative moving path,
wherein the processing unit compares the gravity information and a plurality of driving operation information to select one of the driving operation information as the optimal driving operation information and generates the economical performance information by comparing the optimal driving operation information and the gravity information.

14. The driving efficiency management apparatus according to claim 13, wherein the storage unit comprises:
a path register, for storing the gravity information.

15. The driving efficiency management apparatus according to claim 13 further comprising:
a driving optimal database, for providing the driving operation information.

16. The driving efficiency management apparatus according to claim 1 further comprising:
a memory card slot, for inserting a portable memory card and electrically connecting the portable memory card and the storage unit,
wherein the processing unit stores the driving information, the economical performance information, and the optimal driving operation information into the portable memory card to allow a management center for managing the vehicle to evaluate the driving efficiency of a driver of the vehicle according to information stored in the portable memory card.

17. The driving efficiency management apparatus according to claim 1 further comprising:
a wireless transmission unit, coupled to the storage unit and the processing unit, the wireless transmission unit transmitting the driving information, the economical performance information, and the optimal driving operation information to the management center by an electromagnetic signal,
wherein the management center evaluates the driving efficiency of the driver of the vehicle according to the driving information, the economical performance information, and the optimal driving operation information.

18. A driving efficiency management method, comprising:
a. obtaining a driving information in real time according to the driving condition of a vehicle;
b. comparing the driving information and generating an economical performance information and an optimal driving operation information according to the comparison result; and
c. dynamically displaying the economical performance information or the optimal driving operation information.

19. The driving efficiency management method according to claim 18, wherein step a comprises:
obtaining a vehicle condition information through a connection to a trip computer of the vehicle.

20. The driving efficiency management method according to claim 18, wherein the driving information comprises a longitude/latitude information and the vehicle condition information, and step b comprises:
receiving a GPS satellite signal to obtain the longitude/latitude coordinates of the vehicle and generating the longitude/latitude information according to the longitude/latitude coordinates in real time;
providing a plurality of driving operation information and a plurality of local information;
comparing the longitude/latitude information and the local information to determine whether the driving route of the vehicle passes through a specific road section; and
selecting one of the driving operation information as the optimal driving operation information and generating the economical performance information by comparing the optimal driving operation information and the vehicle condition information when the vehicle runs in the specific road section.
